(19) United States
(12) Patent Application Publication
(10) Pub. No.: US 2008/0295666 A1
(43) Pub. Date: Dec. 4, 2008

(54) SHEET PUNCH DEVICES HAVING CUTTING BLADE FORMED WITH SLANT SURFACE

(75) Inventor: Hyung-Dae BAE, Seoul (KR)

Correspondence Address: STEIN, MCEWEN & BUI, LLP, 1400 EYE STREET, NW, SUITE 300, WASHINGTON, DC, 20005, US

(73) Assignee: DN CRAFT CORPORATION, Seoul (KR)

(21) Appl. No.: 12/117,242

(22) Filed: May 8, 2008

(30) Foreign Application Priority Data
May 29, 2007 (KR) 2007-51956

(51) Int. Cl. B26F 1/14

(52) U.S. Cl. 83/687

(57) ABSTRACT

A sheet punch device comprises a lower base providing a reference plane on which a sheet material is placed and having a jig formed with a pattern hole for punching a sheet material; a punching member aligned onto the lower base and having a cutting blade sliding up and down to pass through the pattern hole of the jig to thereby punch the sheet material; and a slant surface at least partially formed on an edge of the cutting blade, which is at a predetermined angle θ with respect to the outer vertical surface of the cutting blade.

### CROSS-REFERENCE TO RELATED APPLICATION

This application claims the benefit of Korean Application No. 2007-51956, filed May 29, 2007, in the Korean Intellectual Property Office, the disclosure of which is incorporated herein by reference.

### BACKGROUND OF THE INVENTION

1. Field of the Invention

The present invention relates to a punch device for punching a sheet material such as paper, letters and cards, more particularly to a sheet punch device of which a cutting blade has a slant surface formed at its edge facilitating alignment during punching.

2. Description of the Related Art

In general, a punch device has a jig formed with a pattern hole and a punching member having a sharp cutting blade passing through the pattern hole, and punches the same pattern as the pattern hole on a sheet such as paper.

Korean Patent No. 0591639 discloses one of such punches entitled with ‘rotary punch devices’. The punch device comprises an upper plate having a punching member formed with a cutting blade, and a lower plate including a lower jig. Also, the punching member is provided on an upper rotary plate rotatably installed on the upper plate, and the lower plate is provided on a lower rotary plate rotatably installed on the lower plate.

The upper and lower plates have a plurality of magnets on the opposite surfaces, and the upper and lower rotary plates also have a plurality of magnets on the opposite surfaces. First, a user supplies a sheet to be punched on the lower plate, and then places the upper plate on the lower plate for aligning the upper and lower plates by means of an attraction of the magnets to thereby punch the sheet. After that, the upper and lower plates are rotated to be punched with the sheet interposed between the upper and the lower plates and then punched repeatedly.

However, since the upper and lower plates are aligned with the magnets by a user, the punching member and the lower jig are not accurately aligned. Also the alignment just depends on user's manipulation.

As well known, the cutting blade of the punching member should be aligned with the lower jig at high accuracy. FIGS. 1 and 2 show a punching member 10 and a cutting blade 12 according to prior art.

As shown in the drawings, the punching member 10 has a cutting blade 12 which is aligned with pattern hole 22 formed in the lower jig 20 and passes through the pattern hole 22 to punch a sheet. The conventional cutting blade 12 has a sharp point Ps on the outer surface plane, and a slant surface inward from the sharp point. Accordingly, when the cutting blade 12 in inserted into the pattern hole 22 of the lower jig 20, the outer edge of the cutting blade 12 and the lower jig 20 function like a scissors to cut the sheet.

In case that the outer edge of the cutting blade is sharpened, the punching member and the lower jig should be aligned more accurately. Otherwise, when a slight misalignment exists, the sheet is not punched well or a burr is caused in the punched material.

To take the above problems into account, the conventional technology proposed a guide arm and a guide hole separately adopted for alignment of the punching member and the cutting blade. However, the guide means should be separately provided on the punch device while restricting the shape of the punched pattern, and results in a through hole formed by the guide arm on the sheet.

### SUMMARY OF THE INVENTION

The present invention is designed to solve the above problems of the prior art. It is an object of the invention to provide a sheet punch device, in which a cutting blade does not have a sharp point at the outer edge thereof to thereby eliminate the needs for accurate alignment upon punching while the sheet can be punched smoothly.

Another object of the invention is to provide a sheet punch device capable of automatically aligning a punching member and a lower jig during punching without the separate guide arm and guide holes.

In order to accomplish the above object, the present invention provides a sheet punch device comprising: a lower base providing a reference plane on which a sheet material is placed and having a jig formed with a pattern hole for punching a sheet material; a punching member aligned onto the lower base and having a cutting blade sliding up and down to pass through the pattern hole of the jig to thereby punch the sheet material; and a slant surface at least partially formed on an edge of the cutting blade, which is at a predetermined angle θ with respect to the outer vertical surface of the cutting blade.

Preferably, the predetermined angle θ is in the range of 45°˜60°.

Preferably, the slant surface has a height H in the range of 1.0˜2.5 mm.

Also, the jig may be capable of slightly moving laterally.

According to the invention, the lower base comprises a base plate providing a reference plan on which the sheet material is placed, the base plate having a recess onto which the jig is placed to slightly move laterally.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view showing a punching member of the conventional sheet punch device;

FIG. 2 is a schematic view showing a cutting blade and a jig of the conventional sheet punch device;

FIG. 3 is a perspective view showing a sheet punch device according to the preferred embodiment of the present invention;

FIG. 4 is an exploded perspective view schematically showing a sheet punch device according to the preferred embodiment of the present invention;

FIG. 5 is a perspective view schematically showing a punching member of a sheet punch device according to the preferred embodiment of the present invention;

FIG. 6 is a sectional view schematically showing a cutting blade and a jig according to the preferred embodiment of the present invention; and

FIG. 7 is a sectional view schematically showing an alignment of a cutting and a jig in the operation of the present invention.

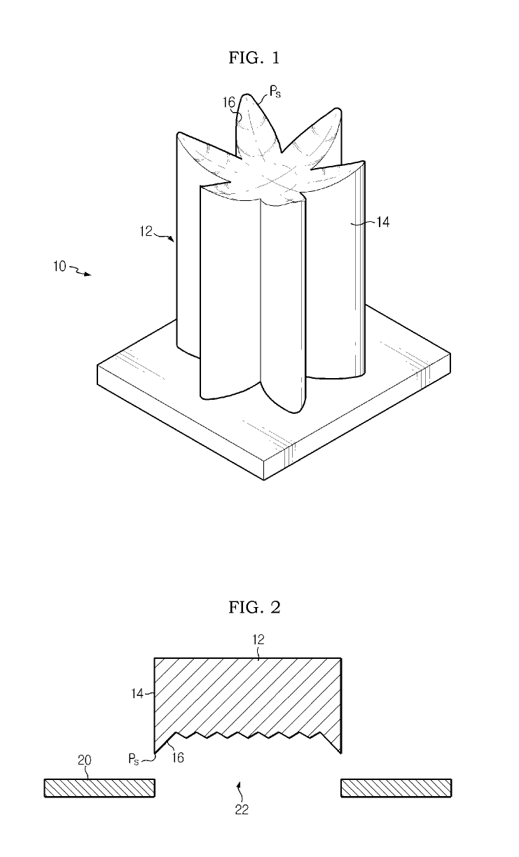

### DETAILED DESCRIPTION OF THE EMBODIMENTS

Hereinafter, preferred embodiments of the present invention will be described in detail with reference to the accompanying drawings. However, it should be understood that the terms in the description and the appended claims should not be construed as limited to general and dictionary meanings, but interpreted based on the meanings and concepts corresponding to technical aspects of the present invention on the basis of the principal that the inventor is allowed to define terms appropriately as a lexicographer.

Therefore, the embodiments herein are just preferable examples for the purpose of illustrating the invention, not intended to limit the scope of the invention, so it should be under stood that other equivalents and modifications could be made thereto without departing from the spirit and scope of the invention.

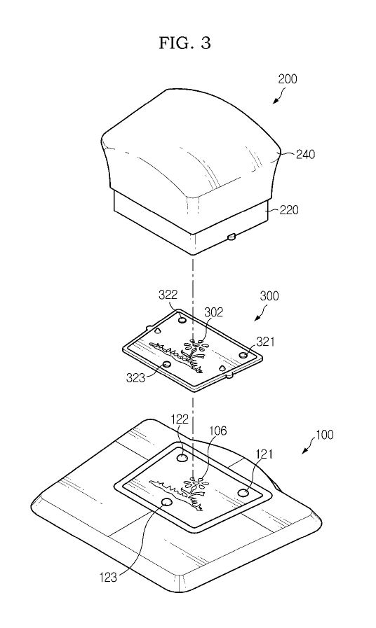

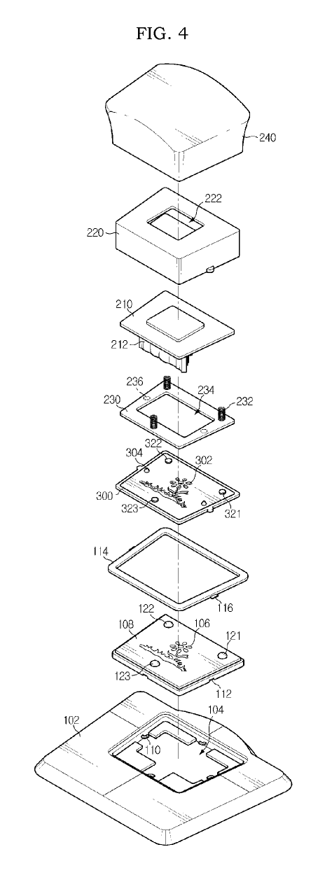

FIGS. 3 and 4 show a sheet punch device according to a preferred embodiment of the present invention. The punch device punches a predetermined pattern in paper, letters or cards (hereinafter referred as ‘a sheet material’).

Referring to the drawings, the sheet punch device of the present invention comprises a lower base 100 providing a reference plane on which a sheet material is placed, a punching unit 200 detachably attached to the upper surface of the lower base 100 and including a punching mechanism for punching the sheet material inside, and a intermediate plate 300 interposed between the lower base 100 and the punching unit 200.

The lower base 100 comprises a base plate 102 providing a flat reference plan on which the sheet material is placed.

A recess 104 is formed on the upper surface of the base plate 102, and a jig 108 having a pattern hole 106 of a predetermined shape formed in the vertical direction rests on the recess 104. Preferably, a plurality of coupling protrusions 110 are formed on the inner side of the recess 104 to connect with connection grooves 112 on the side of the jig 108.

Also, a bracket 114 to press on the edge of the jig 108 is further provided to prevent the jig 108 from escaping from the recess 104. A protrusion 116 on the side of the bracket 114 connects with a groove (not shown) on the side of the recess 104.

More preferably, the recess 104 is slightly larger than the jig 108 so that the jig 108 move laterally to a short distance, which facilitate the alignment of the cutting blade and the pattern hole 106 when punching the sheet material.

The punching unit 200 comprises a punching member 210 sliding up and down through the pattern hole 106 of the jig 108 to punch the sheet material. The punching member 210 has a cutting blade 212 having a shape corresponding to the pattern hole 106 on the lower surface of the punching member 210 to passing through the pattern hole 106 for punching the sheet material.

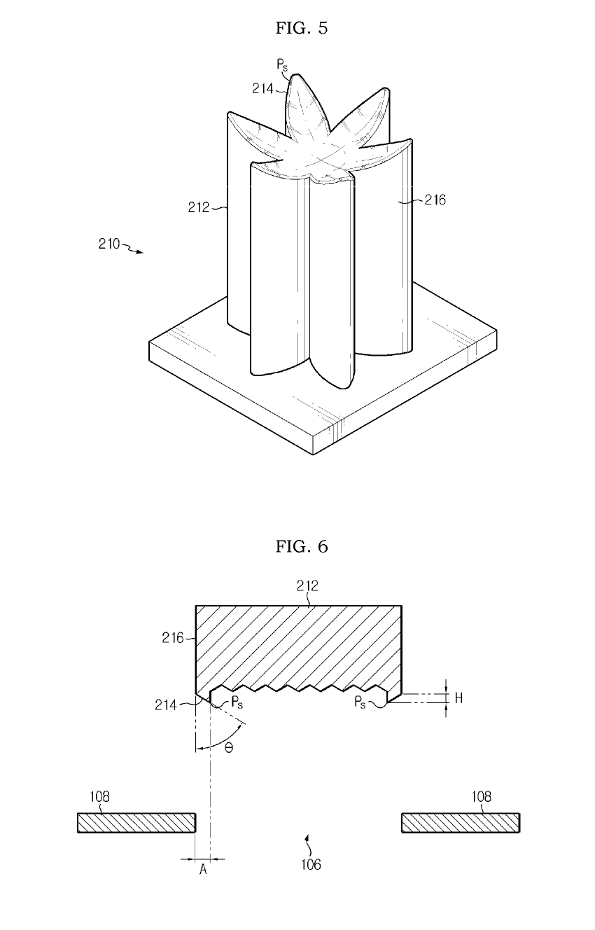

The cutting blade 212 of the punching member 210 according to a preferred embodiment of the present invention is illustrated in FIGS. 5 and 6, which show a part of the pattern.

According to the invention, a slant surface 214 of a predetermined angle is at least partially formed on an edge of the cutting blade 212. That is, the slant surface 214 is at a predetermined angle θ with respect to the outer vertical surface 216 of the cutting blade 212. Accordingly, the sharpest point Ps is positioned more inward than the outer vertical surface 216 of the cutting blade 212.

Preferably, the slant surface 214 is formed on the edge of the longest piece or the outermost piece of the cutting blade 212.

With the slant surface 214 having a proper angle θ of the cutting blade 212, the sheet material ST can be punched smoothly. Attention should be drawn to the fact that whether the sheet material is punched depends on not the sharpness of the cutting blade 212 but the clearance between the cutting blade 212 and the jig 108. The present inventor found that the angle θ would be preferably in the range of 45°˜60°.

When the angle θ is smaller than 45°, a position alignment length A (see FIG. 6) becomes small and the sheet material ST tends to be taken inward by the slant surface 214 during the alignment of the cutting blade 212 and the pattern hole 106 of the jig 108.

On the contrary, when the angle θ is larger than 60°, the slope of the slant surface 214 is not so steep that the alignment cannot be achieved.

Also, inventor's study shows that the ability of punching the sheet material ST relates to the height H of the slant surface 214. Preferably, the height H of the slant surface is in the range of 1.0˜2.5 mm.

Alternatively, the slant surface 214 may be formed on the particular portion of the edge of the cutting blade 212, for example, on the upper, lower, left or right ends of the edge.

The punching member 210 is contained in the housing 220 to be supported upward by an elastic force. In doing so, a support 230 is installed on the lower portion of the punching member 210 while a plurality of elastic members 232 such as a spring are interposed between the punching member 210 and the support 230 to elastically bias the punching member 210 upward.

Also, the support 230 has a guide hole 234 in the form of the same pattern as the pattern hole 106. The cutting blade 212 of the punching member 210 slides up and down while being inserted in the guide hole 234.

The housing 220 also has an opening 222 on the top so that the upper portion of the punching member 210 is exposed out of the housing 220 through the opening 222.

A press member 240 is provided on the housing 220 and a press protrusion (not shown) pressing the upper surface of the punching member 210 is formed on the lower surface of the press member 240.

The sheet punch device comprises an intermediate plate 300 which is separate from the punching unit 200 and detachably installed on the lower base 100 for maintaining the position of the sheet material.

The intermediate plate 300 is formed with a through hole 302 corresponding to the pattern hole 106, through which the cutting blade 212 passes.

Preferably, the intermediate plate 300 is made of a transparent material such as polycarbonate or glass so that a user can see the sheet material under the intermediate plate 300.

More preferably, the intermediate plate 300 is attached to the lower base 100 by means of a magnetic attachment means comprising a plurality of first magnets 121, 122 and 123 provided on the lower base 100, and a plurality of second magnets 321, 322 and 323 corresponding to the first magnets 121, 122 and 123, which is provided on the intermediate plate 300.

Now the operation of the present invention having the above configuration will be described below.

First, the sheet material ST is placed on the lower base 100, and then the intermediate plate 300 is attached onto the lower base 100 with the sheet material ST interposed between them. At this time, the first magnets 121, 122 and 123 provided on the lower base 100 and the second magnets 321, 322 and 323 provided on the intermediate plate 300 are connected each other by a magnetic attraction force.

With the sheet material ST positioned, the punching unit 200 is placed on the lower base 100. At this time, alignment protrusions 304 formed on the intermediate plate 304 interconnect with alignment grooves 236 formed on the support 230 so that the position of the punching unit 200 is determined to the lower base 100.

In such a state, the press member 240 is pressed to punch the sheet material ST. When the press member 240 is pressed, a press protrusion (not shown) presses the punch member 210 downward. Accordingly, the cutting blade 212 passes through the through hole 302 of the intermediate plate 300 to be inserted into the pattern hole 106 of the jig 108.

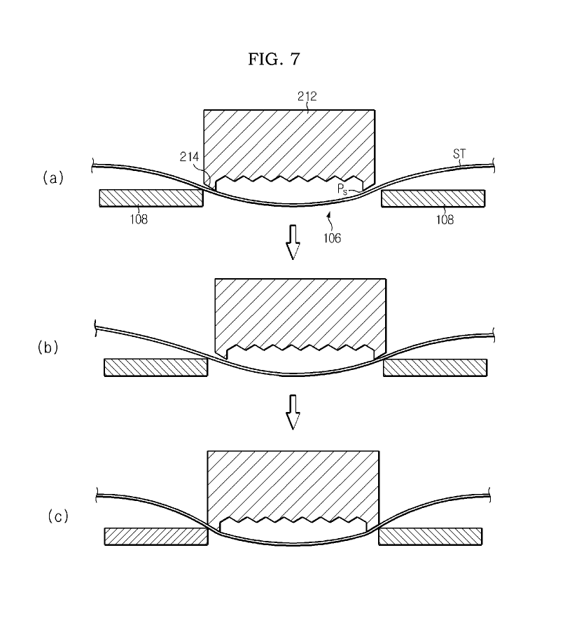

Although the cutting blade 212 is not aligned with the pattern hole 106 of the jig 108 with a high accuracy, the slant surface 214 of the edge of the cutting blade 212 interacts with the edge of the jig 108 at the pattern hole 106 to thereby aligned accurately by the process of (a) through (c) as shown in FIG. 7.

According to the present invention, the jig 108 is capable of slightly moving laterally in the recess 104, which facilitates the alignment as set forth above.

Alternatively, the upper punching unit or the punching member may be configured to slightly move laterally while the jig is fixed.

Subsequently, the press member 240 is pressed more to thereby punch the sheet material ST by the clearance between the cutting blade 212 and the jig on the pattern hole 106.

### Embodiment

Paper having a thickness of 0.20 mm was punched using the sheet punch device as shown in FIG. 4. Here, a slant surface having an angle θ of about 45° and a height H of about 2.0 mm is provided on the edge of the cutting blade. Also, the clearance between the cutting blade and the pattern hole of the jig is about 0.05 mm. It is checked whether the generation of burrs, rumples and tear (dragged-into) with the naked eye.

Comparison

Paper having a thickness of 0.20 mm was punched using the sheet punch device having the same configuration as the above. Here, a slant surface having an angle θ of about 30° and a height H of about 4.0 mm is provided on the edge of the cutting blade. Also, the clearance between the cutting blade and the pattern hole of the jig is about 0.05 mm. It is checked whether the generation of burrs, rumples and tear (dragged-into) with the naked eye.

The resultant data is shown as the following table.

| | Burrs | Rumples | Tear |
|---|---|---|---|
| Invention | None | None | None |
| Comparison | None | Found | Partially found |

Although a few embodiments of the present invention have been shown and described, it would be appreciated by those skilled in the art that changes may be made in this embodiment without departing from the principles and spirit of the invention, the scope of which is defined in the claims and their equivalents. Particularly, the present invention may be applied to all the type of punch devices having the punching member and jig.

According to the present invention, although alignment errors exist between the upper punching member and jig, the slant surface of the outer edge of the cutting blade enables the accurate alignment to punch the sheet material smoothly.

The present invention conducts the automatic alignment of the punching member and the lower jig during punching without separate guide arms and guide holes.

What is claimed is:

1. A sheet punch device comprising:
a lower base providing a reference plane on which a sheet material is placed and having a jig formed with a pattern hole for punching a sheet material;
a punching member aligned onto the lower base and having a cutting blade sliding up and down to pass through the pattern hole of the jig to thereby punch the sheet material; and
a slant surface at least partially formed on an edge of the cutting blade, which is at a predetermined angle θ with respect to the outer vertical surface of the cutting blade.

2. The sheet punch device according to claim 1, wherein the predetermined angle θ is in the range of 45°˜60°.

3. The sheet punch device according to claim 2, wherein the slant surface has a height H in the range of 1.0˜2.5 mm.

4. The sheet punch device according to claim 1, wherein the jig is capable of slightly moving laterally.

5. The sheet punch device according to claim 2, wherein the jig is capable of slightly moving laterally.

6. The sheet punch device according to claim 3, wherein the jig is capable of slightly moving laterally.

7. The sheet punch device according to claim 4, wherein the lower base comprises a base plate providing a reference plan on which the sheet material is placed, the base plate having a recess onto which the jig is placed to slightly move laterally.

8. The sheet punch device according to claim 5, wherein the lower base comprises a base plate providing a reference plan on which the sheet material is placed, the base plate having a recess onto which the jig is placed to slightly move laterally.

9. The sheet punch device according to claim 6, wherein the lower base comprises a base plate providing a reference plan on which the sheet material is placed, the base plate having a recess onto which the jig is placed to slightly move laterally.
